(19) United States
(12) Patent Application Publication
(10) Pub. No.: US 2005/0215295 A1
(43) Pub. Date: Sep. 29, 2005

(54) Ambulatory handheld electronic device

(76) Inventors: Theodore R. Arneson, Ivanhoe, IL (US); Michael L. Charlier, Palatine, IL (US)

Correspondence Address: MOTOROLA INC, 600 NORTH US HIGHWAY 45, ROOM AS437, LIBERTYVILLE, IL, 60048-5343, US

(21) Appl. No.: 10/812,285

(22) Filed: Mar. 29, 2004

(51) Int. Cl. A61H 1/00; A63B 26/00; H04M 1/00

(52) U.S. Cl. 455/575.1; 455/550.1

(57) ABSTRACT

A handheld device (100) comprises a plurality of ambulation mechanisms (222-224, 1002-1008) that enable the handheld device (100) to perform translations, rotations or compound movements on a surface (502) on which the device (100) is placed. Using the ambulation mechanisms (222-224, 1002-1008), the device (100) is able to communicate the occurrence of various events to a user via ambulation gestures that are recognized by the user. Ambulation gestures can be programmed by the user. Disclosed ambulation mechanisms (222-224, 1002-1008) comprise linear (302, 700, 800) or rotary (1018, 1102) vibration transducers that are mechanically coupled to elastic feet (226-228, 606-608, 1110) that have an asymmetric tread (402). The asymmetric tread (402) is effective to convert vibration generated by the vibration transducers (302, 700, 800, 1018, 1102) to movement forces tangential to the surface (502) on which the device (100) is placed.

### FIELD OF THE INVENTION

The present invention relates in general to handheld electronic devices. More particularly, the present invention relates to improvements in user interface aspects of handheld electronic devices.

### BACKGROUND OF THE INVENTION

Handheld portable electronic devices such as, for example wireless communication devices, Personal Digital Assistants (PDA), wireless text messaging devices, handheld electronic games, and MP3 players have increased in popularity over the last decade. This trend has been fostered by improvements in electronics manufacturing technology which have led to smaller, less expensive, and increased functionality devices that are able to operate for longer periods of time on limited battery power.

Two results of improvements in electronics manufacturing technology, namely the ability to make devices that have greater functionality and the ability to make devices smaller come into conflict in respect to user interfaces. Increased functionality suggests the use of a larger interface to enable users to more comfortably interface with more complex devices, however the small size of devices is an obstacle to making their user interfaces larger. Thus, in general, there is a need to improve user interface aspects of handheld electronic devices.

One particular disadvantage of small displays used in handheld devices is that they are not suitable for displaying information in a manner that is visible from a moderate distance. For example if a wireless communication device is placed on a table that is across a room from a user, the user will not be able to read information about an incoming communication, for example caller ID information. Generated speech output through a loudspeaker could be used to communicate information to the user, however such means might disturb others in the vicinity and not fully maintain the privacy of the user.

Thus, in particular, there is a need for allowing a wireless communication device, or other handheld electronic device, to convey information to a user from some distance without disturbing others.

In the case of handheld musical devices, the small size of such devices limits the quality of audio that can be produced. Thus, in this case it would be desirable to enhance the user's experience in listening to music played by the device.

### BRIEF DESCRIPTION OF THE DRAWINGS

The present invention will be described by way of exemplary embodiments, which are not limitations, illustrated in the accompanying drawings in which like references denote similar elements, and in which:

FIG. 1 is a front view of an embodiment of a wireless communication device;

FIG. 2 is a cross sectional side view of the wireless communication device shown in FIG. 1;

FIG. 3 is a fragmentary sectional elevation view of the device shown in FIGS. 1-2 including an electromechanical ambulation mechanism assembly;

FIG. 4 is a perspective view of an elastic foot used in the ambulation mechanism shown in FIG. 3;

FIG. 5 is a broken out sectional view of a tread surface of the elastic foot shown in FIG. 4 indicating various force vectors;

FIG. 6 is a bottom view of the wireless communication device shown in FIGS. 1-2 showing the placement and orientation of ambulation mechanism assemblies;

FIG. 7 is an exploded view of a first embodiment of a linear electromechanical vibration transducer used in the ambulation mechanism shown in FIG. 3;

FIG. 8 is a cross sectional side view of a second embodiment of a linear electromechanical vibration transducer used in the ambulation mechanism shown in FIG. 3;

FIG. 9 is a plan view of a spiral arm leaf spring used in the vibration transducer shown in FIG. 8;

FIG. 10 is an inside view of a rear housing part of an embodiment of a wireless communication device that includes four ambulation mechanisms including rotary electromechanical vibration transducers according to an alternative embodiment;

FIG. 11 is a fragmentary cross sectional view showing a portion of the rear housing part shown in FIG. 10 including one of the ambulation mechanisms shown in FIG. 10;

FIG. 12 is an electrical schematic in block diagram form of the wireless communication device shown in FIGS. 1-2;

FIG. 13 is a flow chart of a first program for operating the wireless communication device shown in FIGS. 1-2 in order to alert a user to a received communication;

FIG. 14 is a flow chart of a second program for operating the wireless communication device shown in FIGS. 1-2 in order to alert a user to a received communication and identify the type of the received communication;

FIG. 15 is a flow chart of a third program for operating the wireless communication device shown in FIGS. 1-2 to learn a sequence of movements demonstrated by the user, and subsequently ambulate approximately according to the sequence of movements in response to user specified events;

FIG. 16 is a flow chart of a fourth program for operating an ambulatory, audio device such as the wireless communication device shown in FIGS. 1-2 in order to make the device move in response to the beat of music in the environment; and

FIG. 17 is a flow chart of a fifth program for operating an ambulatory audio device such as the wireless communication device shown in FIGS. 1-2 in order to make the device move in response to the beat of music being played by the device.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

Although, in the FIGS. a wireless communication device 100 is shown in the form of a ‘candy bar’ form factor cellular telephone, alternatively the wireless communication device 100 has a different form factor. Moreover certain teachings hereinbelow are applicable to other types of handheld electronic devices (such as, for example, PDAs, electronic game devices, and MP3 music players) that are not in the category of wireless communication devices. Certain teachings hereinbelow are also applicable to cordless telephones.

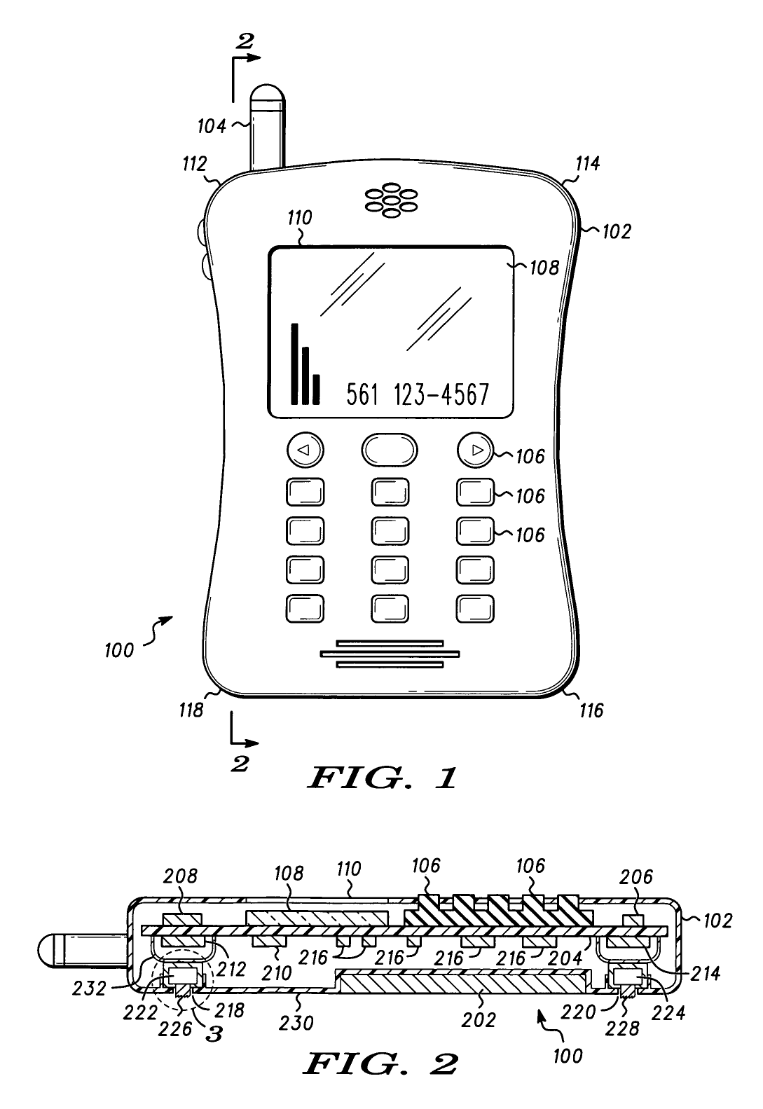

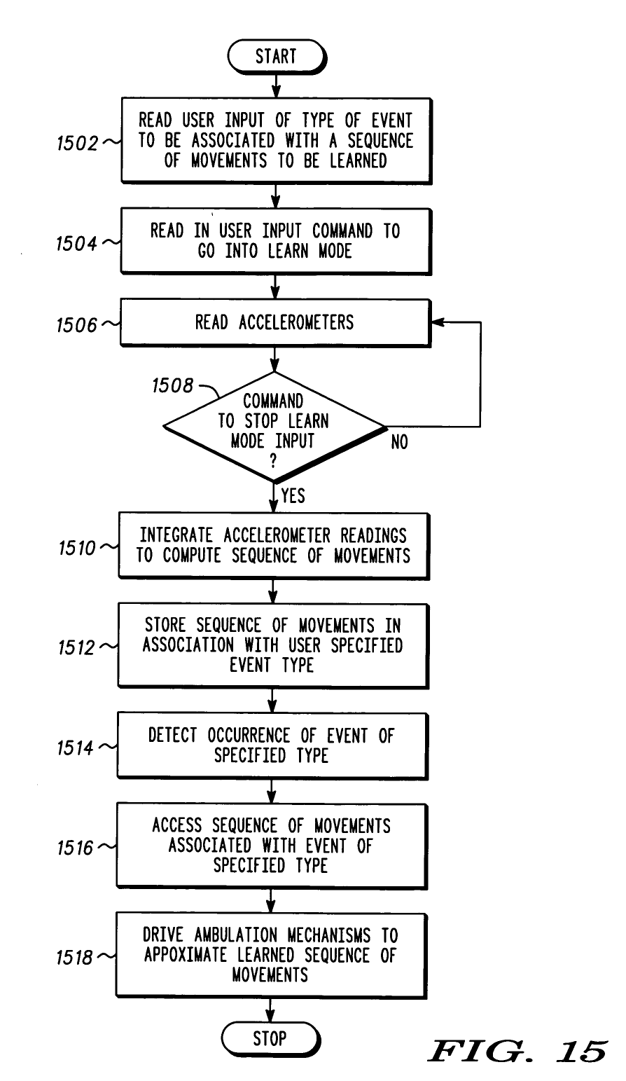

FIG. 1 is a front view of an embodiment of the wireless communication device 100 and FIG. 2 is a cross sectional side view of the wireless communication device 100 shown in FIG. 1. Referring to FIGS. 1-2, a housing 102 holds together components of the wireless communication device 100 including an antenna 104, a keypad 106, a display screen 108, and a battery 202. A window 110 is provided in the housing 102 for viewing the display screen 108. A circuit board 204 located in the housing 102 supports and electrically interconnects the display screen 108, the keypad 106, a microphone 206, an earpiece speaker 208, a loudspeaker 210, a first accelerometer 212, a second accelerometer 214 and a plurality of electrical circuit components 216. The accelerometers 212, 214 are used to measure movement of the wireless communication device 100 as described further below with reference to FIG. 15.

A first opening 218, a second opening 220, a third opening 602 (FIG. 6) and a fourth opening 604 (FIG. 6) are provided in a back wall 230 of the device 100, one at each of four corners 112, 114, 116, 118 of the device 100. Four electromechanical ambulation mechanism including a first 222, and second 224 ambulation mechanism visible in FIG. 2 are located in the housing 102 proximate the four openings 218, 220, 602, 604. Elastic feet of the four ambulation mechanisms 222, 224, including a first elastic foot 226 for the first ambulation mechanism 222, a second elastic foot 228 for the second ambulation mechanism 224, a third elastic foot 606 (FIG. 6) for a third ambulation mechanism, and fourth elastic foot 608 (FIG. 6) for a fourth ambulation mechanism extend through the openings 218, 220, 602, 604 in a back wall 230 of the housing 102 of the device 100. As described more fully below the ambulation mechanisms enable the device 100 to move (translate, rotate or execute compound movements) on a surface on which the device 100 is placed. Discussions of various movements of the device 100 that can be achieved using the ambulation mechanisms 222, 224 is deferred until the discussion below in reference to FIG. 6.

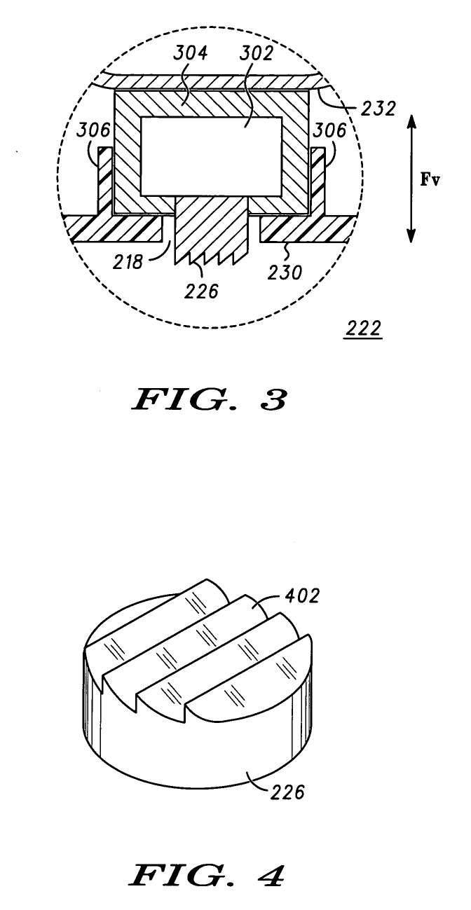

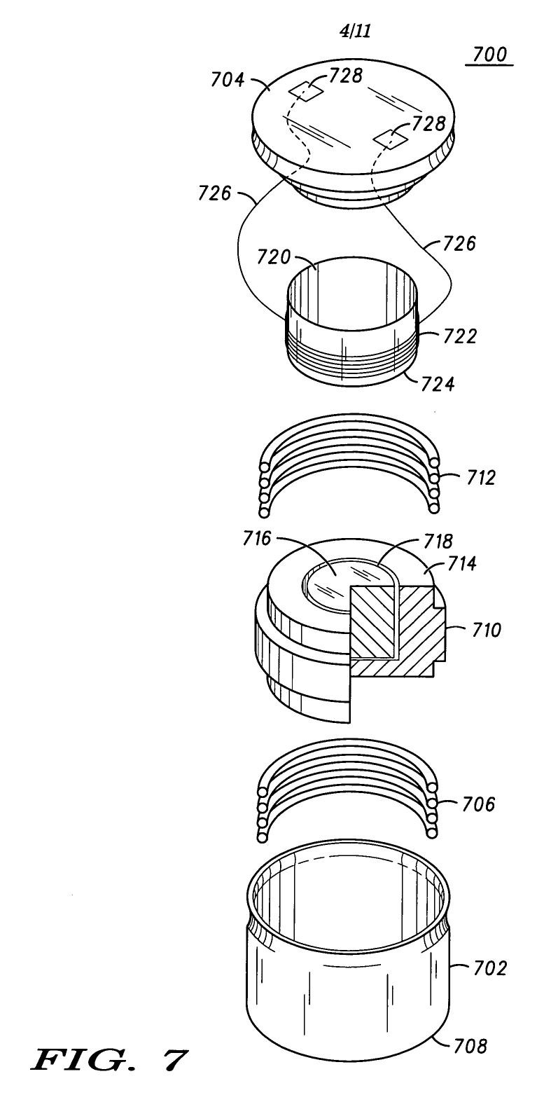

Attention is now directed to a particular design of the ambulation mechanisms 222, 224 etc. FIG. 3 is a fragmentary sectional elevation view of the device 100 shown in FIGS. 1-2 including the first electromechanical ambulation mechanism 222. As shown in FIG. 3 the first ambulation mechanism 222 comprises a linear vibration transducer 302 that is located above and attached to the first elastic foot 226. Internal details of the linear vibration transducer 302 are not shown in FIG. 3; however, two exemplary linear vibration transducers are shown in FIGS. 7-9, described below. Designs other than those shown in FIGS. 7-9 are also acceptable for use in the ambulation mechanisms 222, 224. The elastic foot 226 is suitably affixed to the vibration transducer 302 by adhesive. It is also suitable, in the alternative, to affix the elastic foot 226 to the vibration transducer 302 by mechanical means (not shown). The vibration transducer 302 is partially surrounded (on all sides except the bottom) by an isolation member 304. The isolation member 304 is suitably made out of vibration dampening material. Suitable choices of vibration dampening material include, but are not limited to urethanes, silicones and other rubbers, elastomers, closed cell foams, and open cell foams. One open cell foam that is a suitable choice of vibration damping material is the line of urethane foams sold under the name Confor® by Aero EAR specialty composites of Newark, Delaware. The isolation member 304 can be molded or cut (e.g. die cut or water cut) from the vibration dampening material. The isolation member 304 serves to reduce the coupling of vibrations from the vibration transducer 302 into device 100, and reduce coupling of vibrations from one ambulation mechanism to another.

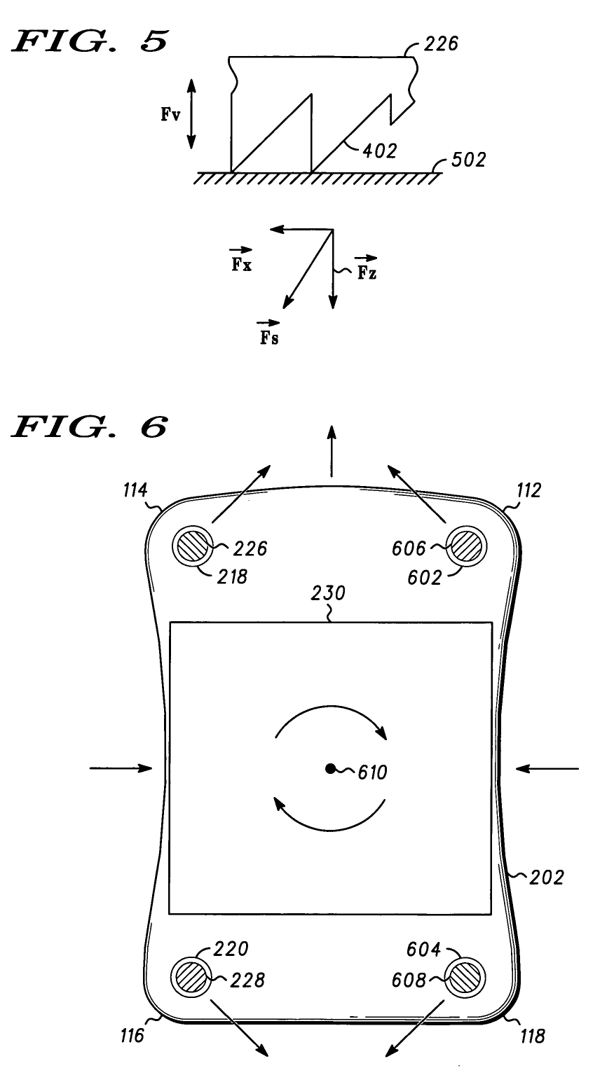

The linear vibration transducer 302 supports the first elastic foot 226 in the first opening 218. The linear vibration transducer 302, surrounded by the isolation member 304 is held in position inside the back wall 230 of the housing 102, by a plurality of ribs 306 that extend from the back wall 230 inward within the housing 102, and held down against the back wall 230 by an electrical component shield 232 that is attached to the circuit board 204. In operation, driving the linear vibration transducer 302 with a periodic signal generates a period vertical force Fv on the elastic foot 226. The operation of the elastic foot 226 to convert this periodic vertical force to transverse movement is described below with reference to FIG. 5.

FIG. 4 is a perspective view of the first elastic foot 226 used in the first ambulation mechanism 222 shown in FIG. 3. As shown in FIG. 4 the elastic foot 226 includes an asymmetric tread 402 that has a profile of a sawtooth waveform. The elastic foot 226 is suitably made of material having a durometer of, for example, 35 to 80 on the Shore A scale. Suitable materials include, but are not limited to urethanes, silicone and other rubbers and elastomers.

FIG. 5 is a broken out sectional view of the tread 402 of the first elastic foot 226 shown in FIG. 4 indicating various force vectors Fx, Fz, Fv, Fs. Owing to the asymmetry of the tread 402, the periodic vertical force Fv due to the linear vibration transducer 302 establish a force Fs on a surface 502 on which the device 100 is placed that is not perpendicular to the surface 502. As shown in FIG. 5 the surface force Fs is resolved into a surface normal component Fz, and a tangential component Fx. A reaction force to the tangential component Fx is believed to be responsible for moving the device 100 when the vibration transducer 302 creates the period vertical force Fv. With each cycle of the vibration force, the device 100 is moved by a small increment by the reaction to the tangential force of the asymmetric tread 402 on the surface 502. During each cycle, the asymmetric tread 402 flexes and rebounds to its original shape. Although, a particular theory of operation of the tread has been presented, the inventors do not wish to be bound by that particular theory of operation.

FIG. 6 is a bottom view of the wireless communication device 100 shown in FIGS. 1-2 showing the placement and orientation of ambulation mechanism assemblies. As seen in FIG. 4 the first elastic foot 226, the second elastic foot 228, the third elastic foot 606, and the fourth elastic foot 608 are shown in the first through fourth openings 218, 220, 602, 604 respectively. A vector arrow adjacent to each particular elastic foot indicates a direction in which the device 100 is pulled (on the surface 502) when a vibration transducer associated with the particular elastic foot is operated. The tread 402 of each elastic foot 226, 228, 606, 608 is oriented perpendicular to the direction of a vector arrow near each elastic foot 226, 228, 606, 608 in FIG. 5, with a slanted face of the tread oriented in the direction of the vector arrow. As shown FIG. 5 the elastic feet in each pair of adjacent elastic feet (i.e., first 226 and second 228; second 228 and fourth 608; fourth 608 and third 606; and third 606 and first 226) are oriented so that one component of the tangential forces established by the elastic feet in the pair cancels, and one component is reinforced. Given the orientations of the elastic feet shown in FIG. 6 the device 100 can be made to translate, rotate, and execute compound movements by selectively operating vibration transducers coupled to the four elastic feet 226, 228, 606, 608. In particular, if the vibration transducers associated with the first 226, and third 606 elastic feet are operated the device 100 will translate up (in the perspective of FIG. 6). If vibration transducers associated with the second 228, and fourth 608 elastic feet are operated the device 100 will translate down. If the vibration transducers associated with the first 226, and second 228 elastic feet are operated the device 100 will translate to the right. If the vibration transducers associated with the third 606, and fourth 608 elastic feet are operated the device 100 will translate to the left. Rotations of the device 100 can also be achieved. If vibration transducers associated with the first 226, and fourth 608 elastic feet are operated the device 100 will rotate clockwise in the perspective of FIG. 6, although viewing the device 100 placed on the surface 502 from above, the device will be seen to rotate counterclockwise. On the other hand if vibration transducers associated with the second 228 and third 606 elastic feet are operated, the device 100 will rotate counterclockwise, as judged from the perspective of FIG. 6. Rotation of the device 100 is enabled by orienting treads of the elastic feet 226, 228, 606, 608 such that tangential surface forces generated by the treads are not radial with respect to a center of mass 610 of the device 100. By operating a vibration transducer associated with one of the elastic feet independently or by operating vibration transducers associated with three of the elastic feet 226, 228, 606, 608 simultaneously, the device 100 is caused to move in compound movements that include rotation and translation.

FIG. 7 is an exploded view of a first embodiment of a linear electromechanical vibration transducer 700 that can be used as the linear vibration transducer 302 of the ambulation mechanisms 222, 224 shown in shown in FIGS. 2-3. The first embodiment of the linear electromechanical vibration transducer 700 comprises cylindrical can housing 702, that is closed by a cap 704. Within the housing 702 a first coil spring 706 that is supported on a bottom 708 of the housing 702 supports a magnetic assembly 710. The magnetic assembly 710 is urged toward the first coil spring 706 by a second coil spring 712 that is located opposite the first coil spring 706 above the magnetic assembly 710. The second coil spring 712 is held in position by the cap 704, when the cap 704 is fitted to the housing 702. The magnetic assembly 710 includes a cup shaped magnetic yoke 714 within which a cylindrical magnet 716 is fitted. An outside diameter of the cylindrical magnet 716 is smaller than an inside diameter of the magnetic yoke 714 so that an annular gap 718 is established between the magnetic yoke 714 and the cylindrical magnet 716. A magnetic field having a substantial radial component crosses the annular gap 718 from the magnet 716, to the magnetic yoke 714. A cylindrical sleeve 720 attaches to the cap 704. A solenoid 722 is wound on a distal end 724 of the cylindrical sleeve 720. In the assembled first vibration transducer 700 the solenoid 722 on a distal end 724 of the cylindrical sleeve 720 is located in the annular gap 718. Leads 726 extend from the solenoid 722 to external contacts 728 in the cap 704. Wires or flex circuitry (not shown) are suitably passed through the isolation member 304 in order to connect to the contacts 728.

The magnetic assembly 710 in combination with the solenoid 722 form a voice coil motor. In operation, when a signal such as, for example, a sinusoid, a multisine, or a square wave is applied to the solenoid 722, a Lorentz force is established between the solenoid 722 and the magnetic assembly 710 such that the magnetic assembly 710 and the housing 702 are caused to reciprocate relative to each other about a fixed relative position established by the coil springs 706, 712. Owing to the mass of the magnetic assembly 710, a substantial vibration of the housing 702 is generated. The vibration of the housing 702 is in turn coupled to an elastic foot, e.g., 226, 228, 606, 608, that is coupled to the housing 702. In use in an ambulation mechanism, an elastic foot is suitably coupled, for example directly attached by adhesive, to the bottom 708 of the housing 702.

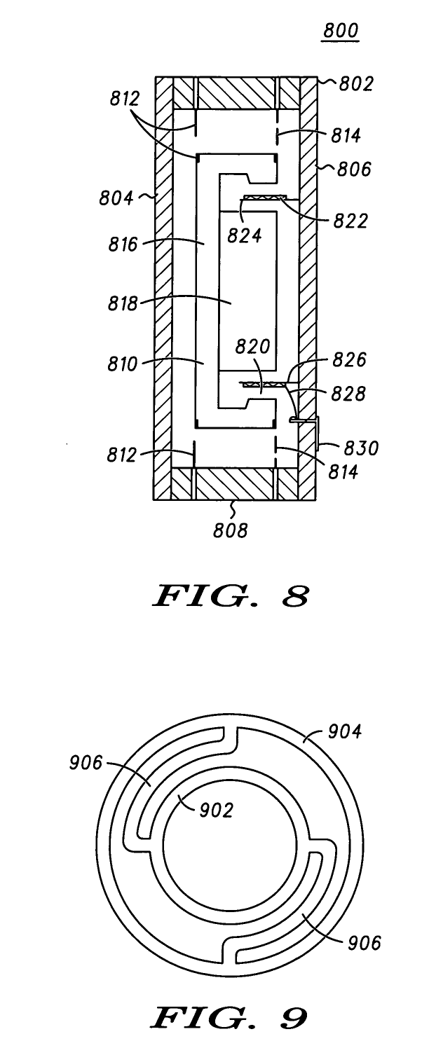

FIG. 8 is a cross sectional side view of a second embodiment of a linear electromechanical vibration transducer 800 that can be used as the linear vibration transducer 302 of the ambulation mechanisms 222, 224 shown in FIGS. 2-3. The second embodiment vibration transducer 800 comprises a housing 802 including a first end wall 804, and a second end wall 806 connected by a cylindrical wall 808. A magnetic assembly 810 is supported within the housing 802 by a first spiral arm leaf spring 812, and a second spiral arm leaf spring 814. FIG. 9 is a plan view of the first spiral arm leaf spring 812 used in the vibration transducer shown in FIG. 8. The second spiral arm leaf spring 814 is suitably of the same design as the first spiral arm leaf spring 812. As shown in FIG. 9, the first spiral arm leaf spring 812 comprises an inner ring 902, and an outer ring 904 connected by a pair of spiral arms 906. The inner ring 902 is attached to the magnetic assembly 810 (e.g., by spot welding), and the outer ring 904 is attached to the cylindrical wall 808 (e.g., by being embedded in the cylindrical wall). The spiral arms 906 provide resilient support of the magnetic assembly 810. The magnetic assembly 810 includes a cup shaped yoke 816, and a cylindrical magnet 818. As in the above described embodiment, an annular gap 820 is located between the cup shaped yoke 816, and the cylindrical magnet 818. A solenoid 822 is wound on a distal end 824 of a cylindrical sleeve 826 that extends from the second end wall 806 into the annular gap 820. Leads 828 of the solenoid 822 extend to electrical contacts 830 integrated into the second end wall 806. The magnetic assembly 810 is biased by the spiral arm leaf springs 812, 814 to a neutral position. When a periodic signal is applied to the solenoid 822, a Lorentz force is established causing the magnetic assembly 810 to oscillate relative to the housing 802 generating a vibration force. In use in an ambulation mechanism, one of the elastic feet 226, 228, 606, 608 is suitably attached to the first end wall 804.

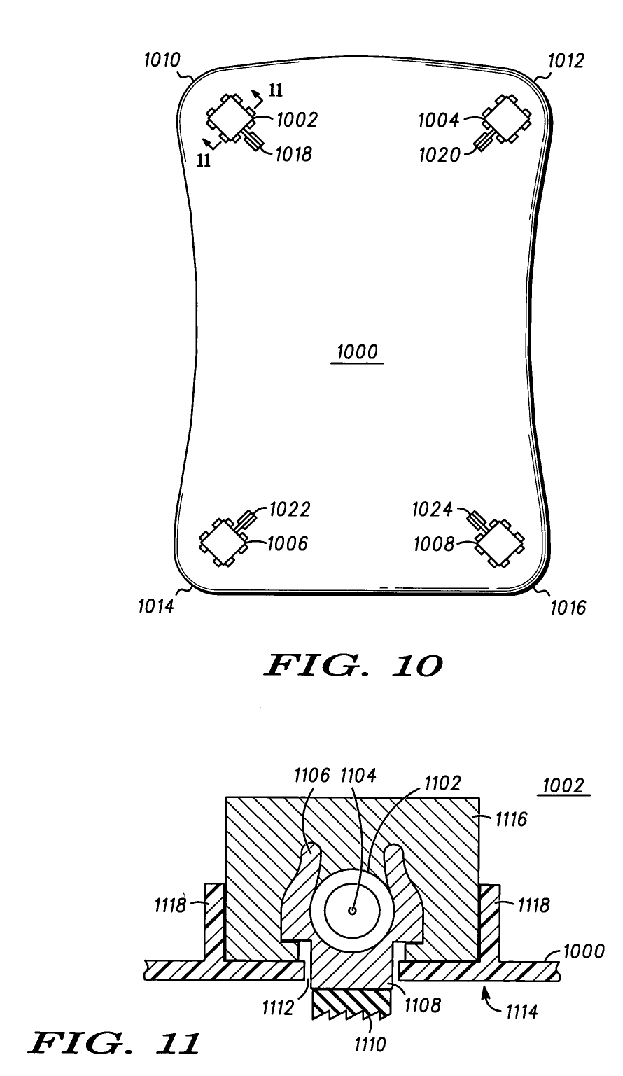

FIG. 10 is an inside view of a rear housing part 1000 of a second wireless communication device that includes four ambulation mechanisms 1002, 1004, 1006, 1008 each including a rotary electromechanical vibration transducer, according to an alternative embodiment. As shown in FIG. 10 the four ambulation mechanisms are positioned at four corners 1010, 1012, 1014, 1016 of the rear housing part 1000, as in the first wireless communication device 100. Each of the four ambulation mechanisms 1002, 1004, 1006, 1008 comprises a rotary vibration transducer. Rotary vibration transducers are currently used in wireless communication devices and pagers to generate vibration alerts. Rotary vibration transducers typically comprise an unbalanced weight connected to, and driven by, a shaft of a small electric motor. In FIG. 10 unbalanced weights 1018, 1020, 1022, 1024 of each of the ambulation mechanisms 1002, 1004, 1006, 1008 are visible.

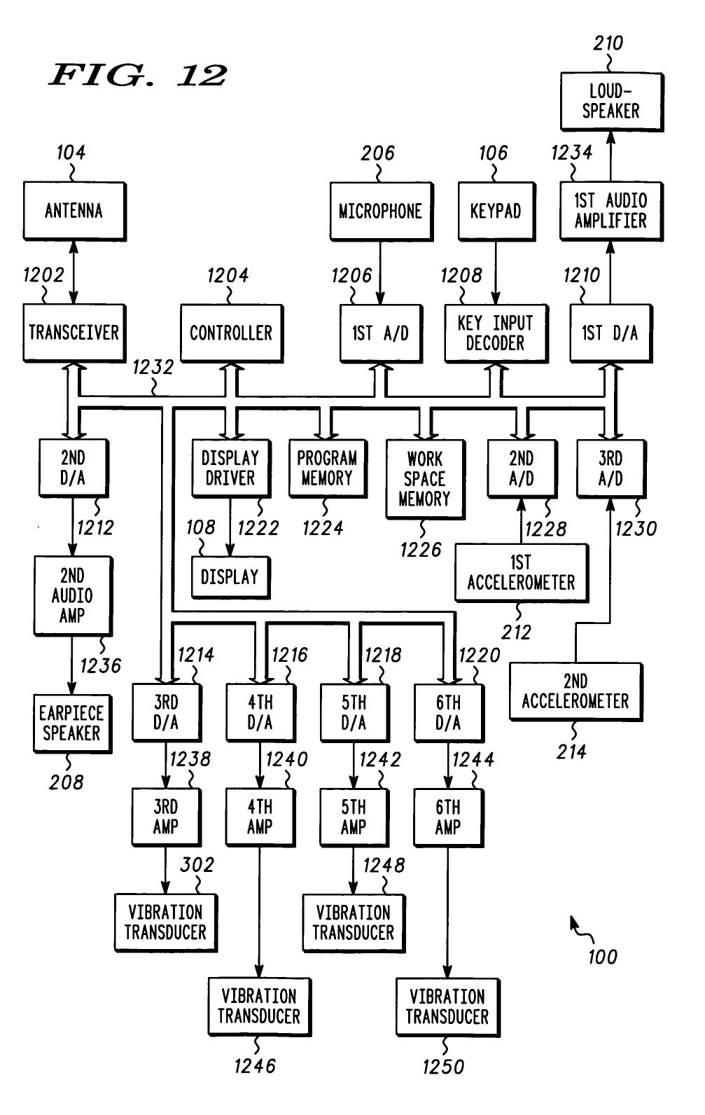

FIG. 11 is a fragmentary cross sectional elevation view of a portion of the rear housing 1000 shown in FIG. 10 including a first 1002 of the ambulation mechanisms 1002, 1004, 1006, 1008. As seen in FIG. 11, the first ambulation mechanism 1002 includes an electric motor 1102 which is represented schematically without internal details. The electric motor includes a shaft 1104 which drives a first 1018 of the unbalanced weights 1018, 1020, 1022, 1024 (which is behind the section plane of FIG. 11, indicated in FIG. 10). The electric motor 1102 is embraced in a motor holder 1106. The motor holder 1106 includes a downwardly extending peg 1108 to which an elastic foot 1110 of the type shown in FIGS. 4, 5 is attached. The peg 1108 extends through an opening 1112 in the rear housing part 1000 such that the elastic foot 1110 resides below a lower surface 1114 of the rear housing part 1000, so as to be able to make contact with a surface on which the rear housing part 1000 is positioned. The motor holder 1106 is partially surrounded circumferentially by an isolation member 1116. The isolation member 1116 which partially encompasses the motor holder 1106 circumferentially, is itself held in position on the rear housing part 1000 with the aid of a plurality of ribs 1118 that extend upward from the rear housing part 1000 in alignment with edges of the isolation member 1116. A circuit board (not shown) of the second wireless communication device is suitably located over the isolation member 1116 so as to hold the isolation member 1116 along with the motor holder 1106, and motor 1102 against the rear housing part 1000.

In operation, driving the motor 1102 causes the first unbalanced weight 1018 to rotate setting up a vibration force that is coupled to the elastic foot 1110. Coupling the vibration force to the elastic foot 1110 causes ambulation of the rear housing part 1000 (along with the remainder of the device to which it is attached) in the manner described above with reference to FIGS. 5-6.

FIG. 12 is an electrical schematic in block diagram form of the wireless communication device 100 shown in FIGS. 1-2. As shown in FIG. 12, the wireless communication device 100 comprises a transceiver module 1202, a controller 1204, a first analog-to-digital converter (A/D) 1206, a key input decoder 1208, a first digital-to-analog converter (D/A) 1210, a second D/A 1212, a third D/A 1214, a fourth D/A 1216, a fifth D/A 1218, a sixth D/A 1220, a display driver 1222, a program memory 1224, a workspace memory 1226, a second A/D 1228, and a third A/D 1230 coupled together through a signal bus 1232.

The transceiver module 1202 is coupled to the antenna 104. Modulated carrier signals for wireless communications pass between the antenna 104 and the transceiver 1202.

The microphone 206 is coupled to the first A/D 1206. The first A/D 1206 serves as an audio signal input circuit. Optionally, a preamplifier (not shown) is included between the microphone 206, and the first A/D 1206. Audio, including words spoken by a user, or music in the environment of the device 100, is input through the microphone 206 and converted to a stream of digital samples by the first A/D 1206.

The keypad 106 is coupled to the key input decoder 1208. The key input decoder 1208 serves to identify depressed keys, and provide information identifying each depressed key to the controller 1204. The display driver 1222 is coupled to the display 108.

The first D/A 1210 is coupled through a first audio amplifier 1234 to the loudspeaker 210. The first D/A 1210 and the first audio amplifier 1234 are parts of a drive circuit for the loudspeaker 210. Samples of decoded digital audio including, for example, spoken words included in a wireless communication, or music received by and/or stored in the device 100 are applied to the first D/A 1210 in order to drive the loudspeaker 210.

The second D/A 1212 is coupled is coupled through a second audio amplifier 1236 to the earpiece speaker 208. Samples of decoded digital audio including, for example, spoken words included in a wireless communication are applied to the second D/A 1212 in order to drive the earpiece speaker 208.

The third 1214, the fourth 1216, the fifth 1218, and the sixth 1220 D/A are coupled through a third amplifier 1238, a fourth amplifier 1240, a fifth amplifier 1242, and a sixth amplifier 1244 respectively to the vibration transducer 302, a second vibration transducer 1246, a third vibration transducer 1248, and a fourth vibration transducer 1250. The four vibration transducers 302, 1246, 1248, 1250 are part of four ambulation mechanisms of the type shown in FIG. 3 that include the four elastic feet 226, 228, 606, 608 shown in FIG. 6. The four vibration transducers 302, 1246, 1248, 1250 can be of the types illustrated in FIGS. 7-9, although these are merely exemplary, and many different vibration transducer designs that are useable are known in the art, and variations on such could be adopted.

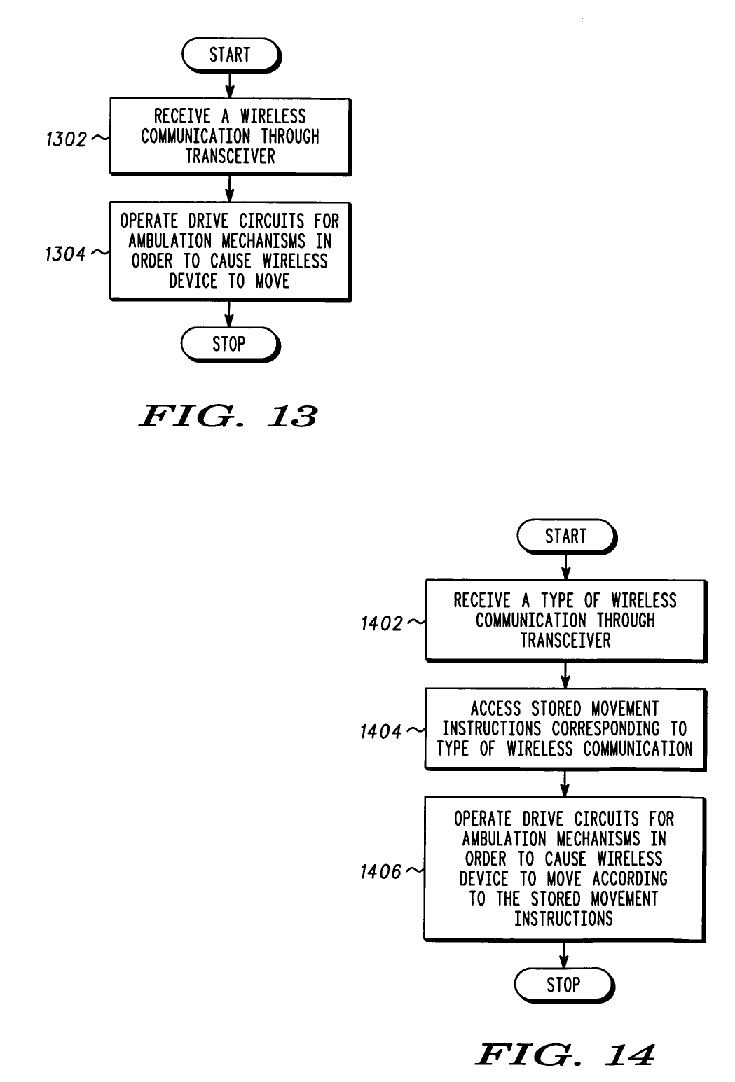

The second A/D 1228 is coupled to the first accelerometer 212, and the third A/D 1230 is coupled to a second accelerometer 214. The second 1228 and third 1230 A/D are used by the controller 1204 to read the accelerometers 212, 214. One or more programs for controlling the operation of the wireless communication device 100, including programs that drive the vibration transducers 302, 1246, 1248, 1250 are stored in the program memory 1224 and executed by the controller 1204. When executing programs stored in the program memory 1224, the controller 1204 is able to drive the vibration transducers by writing signals to the third through sixth D/A 1214, 1216, 128, 1220 through the signal bus 1232. Programs that drive the vibration transducers 302, 1246, 1248, 1250 are described below in more detail with reference to FIGS. 13-17. The workspace memory 1226 is used as temporary storage by the controller 1204.

The transceiver module 1202, the controller 1204, the A/D's 1206, 1228, 1230, the key input decoder 1208, the D/A's 1210, 1212, 1214, 1216, 1218, 1220, the display driver 1222, the program memory 1224, the work space memory 1226, and the amplifiers 1234, 1236, 1238, 1240, 1242, 1244 are embodied in the electrical circuit components 216 and in interconnections of the circuit board 204 shown in FIG. 2.

According to an alternative embodiment, rather than driving the vibration transducers 302, 1246, 1248, 1250 with the amplified output of the third through sixth D/A 1214, 1216, 1218, 1220, the vibration transducers 302, 1246, 1248, 1250 are driven with the output of drive circuits that include one or more oscillators that are either selectively operated, or selectively coupled to the vibration transducers 302, 1246, 1248, 1250, under the control of the controller 1204.

For use in connection with the embodiment shown in FIGS. 10-11 in which ambulation mechanisms that use rotary vibration transducers are used, rather than driving the rotary vibration transducers with amplified output of the third through sixth D/A 1214, 1216, 1218, 1220 drive circuits that include DC voltage or current sources are suitably used.

FIG. 13 is a flow chart of a first program for operating the wireless communication device 100 shown in FIGS. 1-2 in order to alert a user to a received communication. In block 1302 a wireless communication is received through the transceiver 1202. The wireless communication that is received in block 1302 is, for example, a page, a wireless telephone call, a short message service other text message, or a multimedia communication including images, video and/or sound. In block 1304 drive circuits for one or more ambulation mechanisms 222, 224 of the wireless communication device 100 are operated in order to cause the wireless communication device to translate, rotate or perform more complex movements. In the embodiment shown in FIG. 12, the third through sixth D/A 1214, 1216, 1218, 1220, and the third through sixth amplifiers 1238-1244 are parts of drive circuits for the vibration transducers 302, 1246, 1248, 1250. By executing the program shown in FIG. 13 the wireless communication device 100 is able to alert the user to a received communication without using the loudspeaker to sound an audible alert. If the wireless communication device 100 is placed on a surface at some distance from the user, the user will be able to observe the movement of the wireless communication device 100 indicating that a communication has been received.

FIG. 14 is a flow chart of a second program for operating the wireless communication device 100 shown in FIGS. 1-2 in order to alert a user to a received communication and identify the type of received communication. In block 1402 a particular type of wireless communication is received through the transceiver 1202. In block 1404 stored movement instructions, corresponding to the type of wireless communication that was received in block 1402, are accessed, and in block 1406 drive circuits for the ambulation mechanisms of the device 100 are operated to cause the wireless device to move according to the stored movement instructions. The stored movement instructions comprise instructions for one or a sequence of translations, rotations and/or combined movements that correspond to one of a plurality of types of communication. For example, for wireless telephone calls an instruction or sequence of instructions stored in the device 100, e.g., in program memory 1224 can configure the controller 1204 to drive the vibration transducers 302, 1246, 1248, 1250 to cause the device 100 to move in a rotary oscillatory movement in which the device 100 alternates between rotating clockwise and counterclockwise, and, on the other hand, in the case that a text message is received, the device 100 can be caused to alternate between translating right and translating left. The foregoing are merely illustrative examples of distinctive movements used to communicate to a user what type of communication has been received. Note that the stored movement instructions can comprise program code that is reached from a program branch that is contingent on the type of communication that is received, or alternatively data structure(s) that encode a sequence of movements. Thus by implementing the program shown in FIG. 14, a user can not only be alerted that a communication has been received, but also informed of the type of received communication.

FIG. 15 is a flow chart of a third program for operating the wireless communication device 100 shown in FIGS. 1-2 to learn a sequence of movements of the device 100 demonstrated by the user, and subsequently ambulate approximately according to the sequence of movements in response to user chosen events. In block 1502, user input, of a type of event that is to be associated with a movement that is to be learned, is read. For example, the user can specify that the event is a type of communication, such as: a device call, page, text message or multimedia message, a communication from a particular party (e.g., identified by the callers telephone number) or another type of event such as a schedule reminder. Alternatively, the user can specify a group of event types to be associated with the movement that is to be learned.

In block 1504 user input commanding the wireless communication device 100 to go into learn mode is read. The user will have been instructed, for example, by instructions in a user manual or instructions displayed on the display 108, that after the command to go into learn mode is entered, the user is to move the wireless communication device 100 in a sequence of one or more movements that the user would like the wireless communication device 100 to reproduce in order to alert the user to the events of the type specified in block 1502.

In response to the user entering the command to go into learn mode, in block 1506 the accelerometers 212, 214 are read in order to measure the acceleration of the wireless communication device carried out by the user.

Block 1508 is a decision block, the outcome of which depends on whether a command to stop operating in learn mode is received. If not then the program returns to block 1506 and continues to read the accelerometers. If on the other hand a command to stop operating in learn mode is received, then the program continues with block 1510 in which readings of the accelerometer taken in block 1506 are integrated in order to compute the movement of the wireless communication device 100 performed by the user. In integrating the accelerometer readings, the movement is suitably broken down into series of small discrete rotations and translations that can be reproduced using one or more ambulation mechanisms.

In block 1512 the sequence of movements is stored in association with the event type specified by the user in block 1502.

In block 1514, which takes place some arbitrary time later, an occurrence of an event of the type specified in block 1502 is detected, and in response thereto in block 1516 the sequence of movements stored in block 1512 is accessed, and in block 1518 one or more ambulation mechanisms of the wireless communication device 100 are driven in order to approximate the movement learned in blocks 15, 1508, 1510, thereby notifying the user of the occurrence of the event of the specified type, and informing the user of the type of the event. Blocks 1514, 1516, 1518 can be repeated each time an event of the specified type occurs.

Thus, the program shown in FIG. 15 builds on that shown in FIG. 14 in that it allows the user to specify movements to be associated with particular types of events. The programs shown in FIGS. 13-15 extend the user interface capability of the wireless communication device 100 beyond the conventional means of audio, and displayed indicia, allowing the wireless communication device 100 to communicate to the user via ambulation gestures. This extension of the user interface capability is accomplished within the size constraint typically imposed on handheld wireless communication devices.

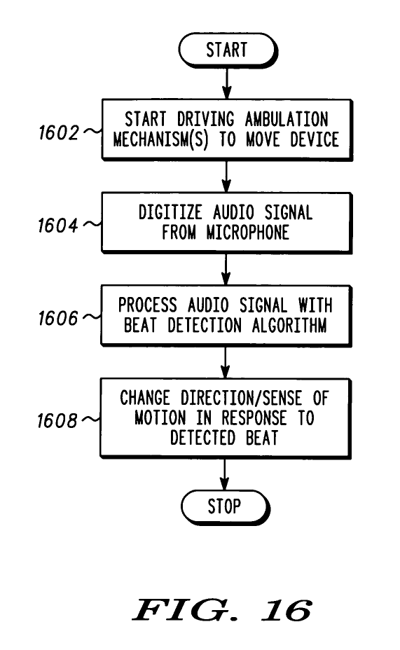

FIG. 16 is a flow chart of a fourth program for operating an audio ambulatory device such as the wireless communication device 100 that includes a microphone, a controller, an A/D for interfacing the microphone and the controller, ambulation mechanisms such as described above, and circuits for interfacing the controller and the ambulation mechanisms, in order to make the device move in response to the beat of music in the environment. In block 1602 operation of one or more ambulation mechanisms are started. The initial movement can be in an arbitrary direction. In block 1604 an audio signal from the microphone (e.g., 206) is digitized. In block 1606 the audio signal is processed with a beat detection algorithm. In the case of the wireless communication device 100 the beat detection algorithm is suitably stored in the program memory 1224, and executed by the controller 1204. In block 1608 the direction or sense of movement is changed in response to a detected beat. Note that block 1604 continues to be performed while block 1606 is started, and blocks 1604 and 1606 continue to be performed while block 1608 is started, so as to continuously process audio in the environment of the device, e.g. wireless communication device 100, in real time.

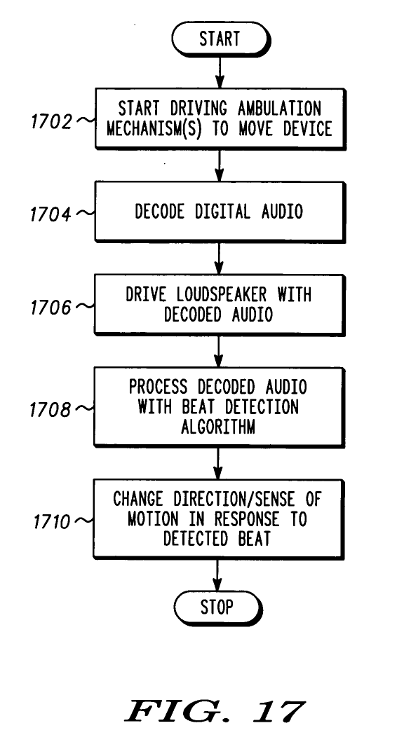

FIG. 17 is a flow chart of a fifth program for operating an audio ambulatory device, such as wireless communication device 100, that includes a controller, a loudspeaker, a D/A for interfacing between the controller and the loudspeaker, and ambulation mechanisms such as described above in order to make the device move in response to the beat of music being played by the device. In block 1702 one or more ambulation mechanisms of the device are started. In block 1704 digital music is decoded. The digital music can be decoded as it is received, i.e., in real time, or as it is read from a memory of the device (e.g. work space memory 1226 or program memory 1224). In block 1706 the loudspeaker is driven through the D/A with the decoded audio. In block 1708 the decoded music is processed with a beat detection algorithm, and in block 1710 the direction and or sense of movement is changed in response to a detected beat of the decoded music. Note that blocks 1704-1710 are performed concurrently such that the device can be moved according to the beat in synchronism with the beat that is heard from the loudspeaker. Note that in performing block 1706 the decoded audio is suitably delayed in order to allow time for the decoded audio to be processed by the beat detection algorithm in order to maintain synchronism between the audible beat and movement of the device according to the beat.

Beyond being applicable to wireless telephones that include added functionality for processing music, the programs shown in FIGS. 16-17 are applicable to other types of devices that are capable of processing music such as for example MP3 music players. MP3 music players that execute the programs shown in FIGS. 16-17 suitably include elements of the cellular telephones shown in FIGS. 1-12 that are needed to carry out the programs, including ambulation mechanisms, a controller, a program memory a D/A, an earpiece speaker or loudspeaker (or alternatively a connector for a separate head set), but need not include the transceiver 1202, and antenna 104. The teachings hereinabove are applicable to wide range of handheld electronic devices.

The programs shown in FIGS. 13-17 are also applicable to a wireless communication device that includes the rear housing part is shown in FIGS. 10-11.

According to an alternative embodiment of the invention, instructions for directing the ambulation are recorded in one wireless communication device (e.g., cellular telephone) and transmitted to a second wireless communication device (e.g., another cellular telephone) in which they are used to direct ambulation. In such an embodiment, a sending device is programmed to perform steps 1504-1512 shown in FIG. 15, and thereafter transmit (e.g., through a cellular network) the sequence of movements to a receiving device. A receiving device is programmed to receive the sequence of movements, and drive its own ambulation mechanisms according to the received sequence of movements. According to this embodiment, users are able to communicate using agreed upon ambulation gestures.

While the preferred and other embodiments of the invention have been illustrated and described, it will be clear that the invention is not so limited. Numerous modifications, changes, variations, substitutions, and equivalents will occur to those of ordinary skill in the art without departing from the spirit and scope of the present invention as defined by the following claims.

1. An handheld electronic device comprising:
a housing;
a first electromechanical transducer included in the housing;
an first foot, for making contact with an external surface on which the handheld electronic device is placed, said first foot being coupled to said first electromechanical transducer, said first foot comprising an asymmetric tread that establishes a direction of movement of the first foot when driven perpendicularly against the external surface by the first electromechanical transducer; and
an electrical drive circuit coupled to the first electromechanical transducer for supplying a drive signal to the first electromechanical transducer to cause the first electromechanical transducer to vibrate.

2. The handheld electronic device according to claim 1 wherein:
the first electromechanical transducer comprises a reciprocating mass, driven by a voice coil motor.

3. The handheld electronic device according to claim 1 wherein the
the first electromechanical transducer comprises:
a rotary electric motor; and
an unbalanced rotating mass coupled to and driven by the rotary electric motor.

4. The handheld electronic device according to claim 1 wherein:
the asymmetric tread is characterized by a sawtooth waveform profile.

5. The handheld electronic device according to claim 1 wherein:
the first electromechanical transducer is coupled to the housing by an isolation member.

6. The handheld electronic device according to claim 1 wherein:
the first electromechanical transducer and the first foot are located at a first corner of the handheld electronic device; and
the handheld electronic device further comprises:
a second electromechanical transducer coupled to a second foot located at a second corner of the handheld electronic device;
a third electromechanical transducer coupled to a third foot located at a third corner of the handheld electronic device; and
a fourth electromechanical transducer coupled to a fourth foot located at a fourth corner of the handheld electronic device.

7. The handheld electronic device according to claim 6 wherein:
the first, second third and fourth feet have treads that are oriented to establish directions of movement that are not radial with respect to a center of mass of the handheld electronic device.

8. The handheld electronic device according to claim 1 further comprising:
an accelerometer; and
a controller coupled to the accelerometer and to the electrical drive circuit.

9. The handheld electronic device according to claim 8 wherein the controller is programmed to:
read a user input specifying a type of event to be associated with a movement to be learned;
read a user input command commanding the controller to go into a learn mode;
in the learn mode, read the accelerometer in order to measure one or more movements of the handheld electronic device carried out by the user; and
thereafter, in response to detecting an event of the specified type operate the electrical drive circuit in order to approximate the one or more movements of the handheld electronic device.

10. A handheld communication device comprising:
an electromechanical ambulation mechanism;
a drive circuit coupled to the electromechanical ambulation mechanism;
a controller coupled to the drive circuit;
a memory storing a control program, coupled to the controller; and
a transceiver coupled to the controller.

11. The handheld communication device according to claim 10 wherein:
the controller is programmed by the control program stored in the memory to:
operate the transceiver to receive a communication; and
in response to receiving the communication:
operate the drive circuit in order to drive the electromechanical ambulation mechanism.

12. The handheld communication device according to claim 10 wherein:
the memory also stores a plurality of movement instructions, each of which is associated with a particular type of communication; and
the controller is programmed by the control program stored in the memory to:
operate the transceiver to receive a communication;
access one of the movement instructions that is associated with the particular type of the received communication; and
operate the drive circuit according to the movement instructions associated with the particular type of the received communication,
whereby, in response to receiving communications, the handheld communication device moves in a distinctive way that identifies the type of received communication.

13. The handheld communication device according to claim 10 further comprising:
an accelerometer coupled to the controller;
wherein the controller is programmed to:
read a first a user input specifying a type of event that is to trigger a movement that is to be learned;
read a second user input commanding the controller to go into a learn mode;
in the learn mode, read the accelerometer in order to measure one or more movements of the handheld communication device performed by the user; and
thereafter, in response to detecting an event of the type specified by the user, operate the drive circuit in order to mimic the one or more movements of the handheld communication device performed by the user.

14. A handheld audio device comprising:
a housing, said housing holding:
a controller;
at least one memory storing a control program for operating the handheld audio device, said at least one memory coupled to the controller;
an audio system coupled to the controller;
an ambulation system comprising:
an electromechanical ambulation mechanism;
a first drive circuit coupled to the electromechanical ambulation mechanism, and coupled to the controller;
wherein, the controller is programmed to drive the ambulation system in response to audio processed by the audio system.

15. The handheld audio device according to claim 14, wherein:
said audio system comprises a loudspeaker, and a second drive circuit coupled to the loudspeaker.

16. The handheld audio device according to claim 14 wherein:
the controller is programmed to digitally process digital audio to obtain processed audio and drive the ambulation system according to the processed audio.

17. The handheld audio device according to claim 16 wherein:
the controller is programmed to process digital music with a beat detection algorithm, in order to detect one or more beats, and operate the ambulation system so as to change a movement of the handheld audio device in response to the one or more beats.

18. The handheld audio device according to claim 14 wherein:
said audio system comprises a microphone; and
wherein the controller is programmed by the control program to:
process input audio signals received from the microphone to obtain processed audio; and
operate the electromechanical ambulation mechanism according to the processed audio.

19. The handheld audio device according to claim 18 wherein:
the controller is programmed to process input audio signals received from the microphone with a beat detection algorithm to detect one or more beats and operate the electromechanical ambulation mechanism to change a movement of the handheld audio device in response to the one or more beats.

20. A method of operating two devices in a wireless communication system, the method comprising:
in a first device, reading an accelerometer in order to measure one or more movements of the first device; and
transmitting information as to the one or more movements to a second device;
in the second device, receiving the information as to the one or more movements; and
driving one or more ambulation mechanism of the second device in order to move the second device according to the information as to the one or more movements of the first device.

21. The method according to claim 20 wherein:
the information as to the one or more movements of the first device is transmitted via a cellular network.
